(19) United States
(12) Patent Application Publication
(10) Pub. No.: US 2005/0178223 A1
(43) Pub. Date: Aug. 18, 2005

(54) Reciprocating device for a power saw

(76) Inventors: Chengdao Li, Suzhou (CN); Liangbin Liu, Suzhou (CN)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/031,924

(22) Filed: Jan. 7, 2005

(30) Foreign Application Priority Data
Jan. 12, 2004 (CN) 200420024258.7

(51) Int. Cl. F16H 21/16

(52) U.S. Cl. 74/25

(57) ABSTRACT

The present invention relates to a reciprocating device for a power saw which includes a gear box, a main spindle, a rotary gear driven by the main spindle, a rotary transmission shaft fixed to the gear, a pair of support members and a reciprocating rod unit capable of moving reciprocatively, wherein the rotary transmission shaft and the main spindle are non-parallel to each other. The gear is arranged substantially between the pair of support members, thereby minimizing the space occupied by the internal structure of the reciprocating device and the weight of the power saw.

### FIELD OF THE INVENTION

The present invention relates to a reciprocating device for a power saw and to a power saw comprising the reciprocating device.

### BACKGROUND

A conventional reciprocating device for a power saw generally includes a gear box, a motor-driven rotary gear, an eccentric spindle fixed to the rotary gear, a pair of support members and a reciprocating rod unit which is driven by the eccentric spindle to move reciprocatively. Typically the support members are bearings which are used to support the eccentric spindle. The rotary gear is disposed outside the pair of support members which increases the volume occupied by the reciprocating device and the weight and manufacturing cost thereof.

### SUMMARY OF THE INVENTION

A main object of the present invention is to provide a reciprocating device having a low volume structure.

The present invention relates to a reciprocating device for a power saw including a gear box, a main spindle, a rotary gear driven by the main spindle, a rotary transmission shaft fixed to the gear, a pair of support members and a reciprocating rod unit capable of moving reciprocatingly. The rotary transmission shaft and the main spindle are non-parallel to each other. The rotary gear is substantially arranged between the pair of support members.

By positioning the rotary gear substantially between the pair of support members rather than outside the support members, the volume occupied by (and therefore the weight of) the internal structure of the reciprocating device is advantageously minimized.

Viewed from a first aspect the present invention provides a reciprocating device for a power saw comprising:
an elongate gear box,
a main spindle extending axially into the gear box,
a rotary gear driven by the main spindle having a proximal face and a distal face,
a pair of support members within the gear box, wherein the rotary gear is arranged substantially coaxially between the pair of support members,
a rotary transmission shaft extending between a proximal end and a distal end in a direction which is non-parallel (eg substantially perpendicular) to the axis of the main spindle, wherein the proximal end is meshed axially with the rotary gear and a coupling rod for coupling the distal end of the rotary transmission shaft to a reciprocative saw blade.

The or each support member may be a bearing. The bearing is typically an annular bearing. The first of the support members is preferably seated on a fixed part of the gear box (eg a fixed end cover). A second of the support members is preferably positioned adjacent to the proximal face of the rotary gear.

In a preferred embodiment, the distal face of the rotary gear extends axially into a cylindrical hub and the first of the pair of support members is mounted radially on the cylindrical hub. The proximal end of the rotary transmission shaft may be meshed with the interior of the cylindrical hub. For example, there may be multiple splines on the proximal end of the rotary transmission shaft engaging complementary multiple splines on the interior of the cylindrical hub.

Preferably the second of the pair of support members is positioned adjacent to the proximal face of the rotary gear and is radially mounted (eg radially mounted slidingly) on the rotary transmission shaft to retain the rotary transmission shaft in the gear box.

In a preferred embodiment, the coupling rod is disposed outside the pair of support members.

In a preferred embodiment, a bevel gear is formed at the end of the main spindle, wherein the bevel gear meshes radially with the proximal face of the rotary gear. Preferably the bevel gear is made up of multiple splines.

In a preferred embodiment, the reciprocating device further comprises:
a rotary bell crank for linking the rotary transmission shaft and the coupling rod.

Preferably the rotary bell crank has a planar linkage body with an upper face and a lower face, wherein the lower face is fixed to the proximal end of the rotary transmission shaft and the upper face is fixed to an eccentric axle, wherein the coupling rod is mounted on the eccentric axle so as to cause the reciprocative saw blade to move reciprocatively. Preferably the planar linkage body, rotary transmission shaft and eccentric axle are an integral body.

In a preferred embodiment, the reciprocating device further comprises:
a guiding plate fixed in the gear box,
an eccentric block formed at the distal end of the rotary transmission shaft and
a balancing block mounted on the eccentric block. Preferably the direction of movement of the balancing block is opposite to that of the coupling rod and the balancing block is rollingly mounted on the guiding plate. Preferably the balancing block defines a plurality
of slots and the reciprocating device further comprises: a plurality of rolling members partially received in corresponding slots to enable the balancing block to be rollingly mounted on the guiding plate.

In a preferred embodiment, an eccentric block is integrally formed on the lower face of the linkage body and the reciprocating device further comprises: a guiding plate fixed in the gear box,
a slotted balancing block mounted rollingly between the guiding plate and the planar linkage body, wherein the slotted balancing block defines a plurality of slots and an aperture which engages the eccentric block. Preferably the reciprocating device further comprises: a plurality of rolling members partially received in the plurality of slots to enable the slotted balancing block to be rollingly mounted on the guiding plate.

The eccentric block is typically diametrically opposite to the eccentric axle. Preferably the planar linkage body, rotary transmission shaft, eccentric axle and eccentric block are an integral body.

Viewed from a further aspect the present invention provides an eccentric reciprocating device for a power saw including a gear box, a main spindle, a rotatable gear driven by the main spindle, a gear shaft fixed to the gear, a pair of support members and a reciprocating rod unit moving reciprocatingly, wherein the gear shaft and the main spindle being non-parallel with each other, wherein the gear being substantially arranged between the pair of support members.

Viewed from a yet further aspect the present invention provides a power saw comprising:
a housing;
a motor disposed in the housing;
a reciprocating device comprising:
an elongate gear box,
a motor-driven main spindle extending axially from the housing into the gear box,
a rotary gear driven by the main spindle having a proximal face and a distal face,
a pair of support members within the gear box, wherein the rotary gear is arranged substantially coaxially between the pair of support members,
a rotary transmission shaft extending between a proximal end and a distal end in a direction which is non-parallel to the axis of the main spindle, wherein the proximal end is meshed axially with the rotary gear and
a coupling rod for coupling the distal end of the rotary transmission shaft to a reciprocative saw blade.

### BRIEF DESCRIPTION OF THE DRAWINGS

FIG. 1 is a partial cross-sectional view of an embodiment of the power saw of the present invention;

FIG. 2 is an enlarged cross-sectional view along line A-A;

FIG. 3 is an enlarged view within circle B; and

FIG. 4 is an exploded perspective view of the reciprocating device of FIG. 1.

### DETAILED DESCRIPTION OF A PREFERRED EMBODIMENT

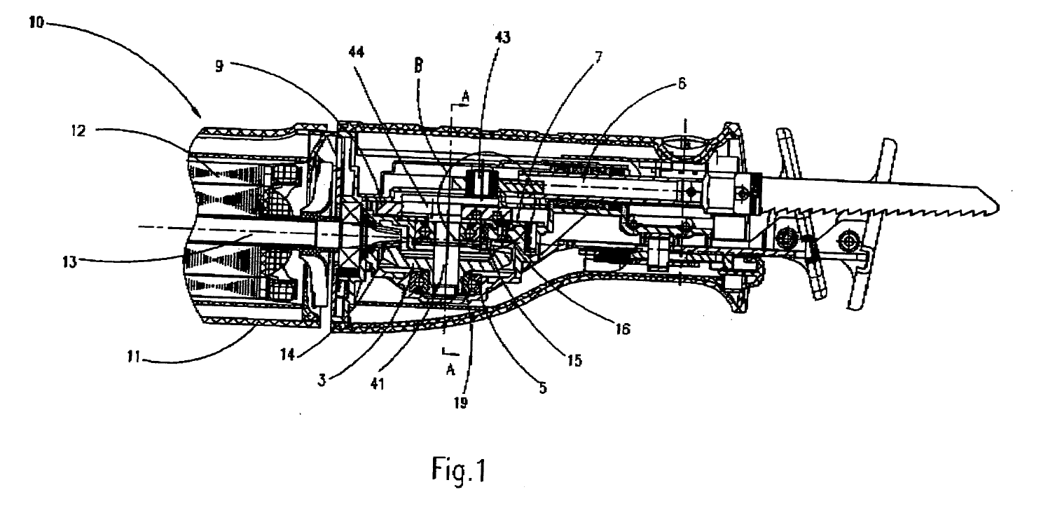

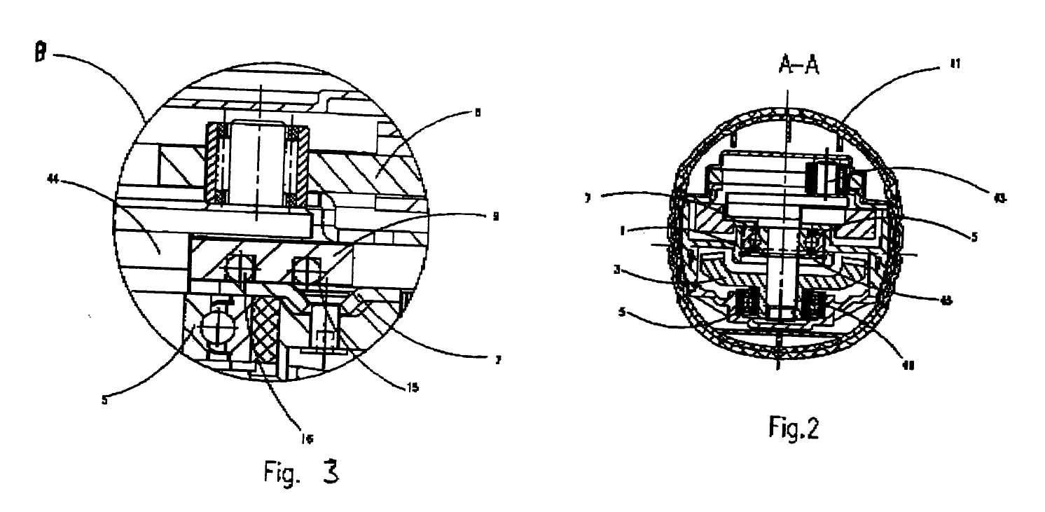

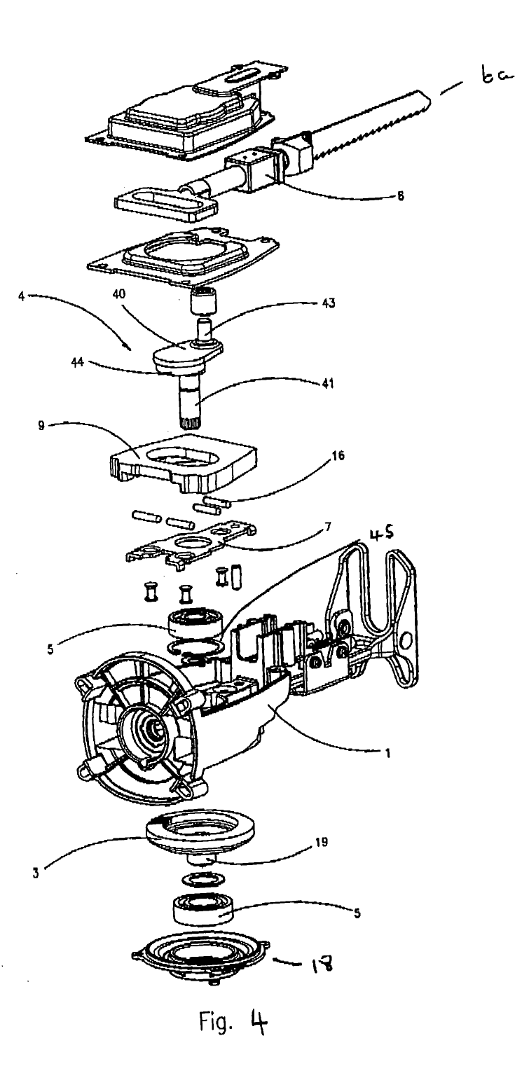

Referring to FIGS. 1 to 4, a power saw 10 includes a housing 11, a motor 12 disposed in the housing 11 and a reciprocating device driven by the motor 12. The reciprocating device includes generally an elongate gear box 1 into which extends axially a main spindle 13 of the motor 12, a rotary gear 3 driven by the main spindle 13, a rotary transmission shaft 41 meshed axially with the rotary gear 3, a pair of support members 5 in the form of bearings which support the rotary transmission shaft 41 and rotary gear 3 and a coupling rod 6 for coupling the rotary transmission shaft 41 to a reciprocative saw blade 6a. The rotary transmission shaft 41 and the main spindle 13 are positioned substantially perpendicular to each other.

A bevel gear 14 constituting multiple splines formed at the end of the main spindle 13 mesh radially with corresponding splines on the perimeter of the proximal face of the rotary gear 3. The distal face of the rotary gear 3 extends axially into a cylindrical hub 19 which is sleeved on the distal end of the rotary transmission shaft 41. Multiple splines on the end of the rotary transmission shaft 41 mesh multiple splines on the inner circumference of the end of the cylindrical hub 19. A first of the support members 5 is mounted radially on the cylindrical hub 19 and is seated on a fixed end cover 18. A second of the support members 5 is positioned adjacent to the proximal face of the rotary gear 3 supported on a resilient retainer ring 45 and is radially mounted on the rotary transmission shaft 41 to retain the rotary transmission shaft 41 in the gear box 1. In this manner, the rotary gear 3 is positioned between the pair of support members 5 thereby minimizing the volume and weight of the power saw 10.

A rotary bell crank 4 has a planar linkage body 40. The lower face of the linkage body 40 is fixed to the proximal end of the rotary transmission shaft 41 with which it rotates. The upper face of the linkage body 40 is fixed to an eccentric axle 43. The coupling rod 6 is mounted on the eccentric axle 43 so as to cause the saw blade 6a to move reciprocatively. An eccentric block 44 is integrally formed at the proximal end of the rotary transmission shaft 41 on the lower face of the linkage body 40.

The reciprocating device further includes a guiding plate 7 fixed in the gear box 1 and a slotted balancing block 9 mounted between the guiding plate 7 and the planar linkage body 40. The slotted balancing block 9 defines a plurality of slots 15 and an aperture 9a which engages the eccentric block 44. A plurality of rolling members 16 are partially received in corresponding slots 15 to enable the slotted balancing block 9 to be rollingly mounted on the guiding plate 7. The direction of movement of the balancing block 9 is opposite to that of the reciprocating rod unit 6 thereby balancing the impulse generated by the reciprocating rod unit 6 so as to reduce vibration generated thereby. A rolling friction (rather than a sliding friction) is formed between the slotted balancing block 9 and the guiding plate 7 which serves to reduce friction therebetween so as to reduce the heat produced by the friction. This reduces the load of the power saw thereby increasing its operational reliability.

1. A reciprocating device for a power saw comprising:
an elongate gear box,
a main spindle extending axially into the gear box,
a rotary gear driven by the main spindle having a proximal face and a distal face,
a pair of support members within the gear box, wherein the rotary gear is arranged substantially coaxially between the pair of support members,
a rotary transmission shaft extending between a proximal end and a distal end in a direction which is non-parallel to the axis of the main spindle, whereint he proximal end is meshed axially with the rotary gear and
a coupling rod for coupling the distal end of the rotary transmission shaft to a reciprocative saw blade.

2. The reciprocating device of claim 1 wherein the pair of support members are a pair of bearings.

3. The reciprocating device of claim 1 wherein the distal face of the rotary gear extends axially into a cylindrical hub and a first of the pair of support members is mounted radially on the cylindrical hub.

4. The reciprocating device of claim 3 wherein the first of the pair of support members is seated on a fixed part of the gear box.

5. The reciprocating device of claim 4 wherein the second of the pair of support members is positioned adjacent to the proximal face of the rotary gear and is radially mounted on the rotary transmission shaft.

6. The reciprocating device of claim 1 wherein the coupling rod is disposed outside the pair of support members.

7. The reciprocating device of claim 1 wherein a bevel gear is formed at the end of the main spindle, wherein the bevel gear meshes radially with the proximal face of the rotary gear.

8. The reciprocating device of claim 1 further comprising:
a rotary bell crank for linking the rotary transmission shaft and the coupling rod.

9. The reciprocating device of claim 8 wherein the rotary bell crank has a planar linkage body with an upper face and a lower face, wherein the lower face is fixed to the proximal end of the rotary transmission shaft and the upper face is fixed to an eccentric axle, wherein the coupling rod is mounted on the eccentric axle so as to cause the reciprocative saw blade to move reciprocatively.

10. The reciprocating device of claim 1 further comprising:
a guiding plate fixed in the gear box,
an eccentric block formed at the distal end of the rotary transmission shaft and
a balancing block mounted on the eccentric block.

11. The reciprocating device of claim 10 wherein the direction of movement of the balancing block is opposite to that of the coupling rod and the balancing block is rollingly mounted on the guiding plate.

12. The reciprocating device of claim 10 wherein the balancing block defines a plurality of slots and the device further comprises:
a plurality of rolling members partially received in corresponding slots to enable the balancing block to be rollingly mounted on the guiding plate.

13. The reciprocating device of claim 9 wherein an eccentric block is integrally formed on the lower face of the linkage body, said reciprocating device further comprising:
a guiding plate fixed in the gear box,
a slotted balancing block mounted rollingly between the guiding plate and the planar linkage body, wherein the slotted balancing block defines a plurality of slots and an aperture which engages the eccentric block.

14. The reciprocating device of claim 13 further comprising:
a plurality of rolling members received in the plurality of slots to enable the slotted balancing block to be rollingly mounted on the guiding plate.

15. An eccentric reciprocating device for a power saw including a gear box, a main spindle, a rotatable gear driven by the main spindle, a gear shaft fixed to the gear, a pair of support members and a reciprocating rod unit moving reciprocatingly, wherein the gear shaft and the main spindle being non-parallel with each other, wherein the gear being substantially arranged between the pair of support members.

16. A power saw comrising:
a housing
a motor disposed in the housing:
a reciprocating device comprising:
an elongate gear box,
a motor-driven main spindle extending axially from the housing into the gear box,
a rotary gear driven by the main spindle having a proximal face and a distal face,
a pair of support members within the gear box, wherein the rotary gear is arranged substantially coaxially between the pair of support members,
a rotary transmission shaft extending between a proximal end and a distal end in a direction which is non-parallel to the axis of the main spindle, wherein the proximal end is meshed axially with the rotary gear and
a coupling rod for coupling the distal end of the rotary transmission shaft to a reciprocative saw blade.
